(19) United States
(12) Patent Application Publication
(10) Pub. No.: US 2024/0299256 A1
(43) Pub. Date: Sep. 12, 2024

(54) MEDICATION MANAGEMENT SYSTEM

(71) Applicant: EllieGrid, Inc., Sugar Land, TX (US)

(72) Inventors: Luis Abelardo Matamoros, Houston, TX (US); Hieu Nguyen, Houston, TX (US); Regina Vatterott, Houston, TX (US)

(21) Appl. No.: 18/180,742

(22) Filed: Mar. 8, 2023

(51) Int. Cl. A61J 7/04; A61J 7/00

(52) U.S. Cl. CPC A61J 7/0436; A61J 7/0069; A61J 2200/30; A61J 2200/70

(57) ABSTRACT

A medication organizer includes a sensor and a processor operably coupled to the sensor. The sensor is configured to detect an interaction with the medication storage container. The processor is configured to determine that a medication consumption period is active. The processor is also configured to determine that the sensor has not detected an interaction with the medication storage container during the medication consumption period. The processor is further configured to activate a notification based on not detecting an interaction with the medication storage container during the medication consumption period.

### TECHNICAL FIELD

This disclosure relates generally to medical management devices and processes. More specifically, this disclosure relates to a device for improved regulation of medications.

### BACKGROUND

People have died due to incorrect consumption of medicine. The odds of harm caused by incorrect consumption of medicine increases for people that require multiple medications, medications with multiple daily dosages, medications required at specific times of the day, etc. Because of these complexities, organizing medications can require multiple devices for storage, planning, reminders, etc.

### SUMMARY

This disclosure provides a medical management system.

In a first embodiment, a medication organizer includes a sensor and a processor operably coupled to the sensor. The sensor is configured to detect an interaction with the medication storage container. The processor is configured to determine that a medication consumption period is active. The processor is also configured to determine that the sensor has not detected an interaction with the medication storage container during the medication consumption period. The processor is further configured to activate a notification based on not detecting an interaction with the medication storage container during the medication consumption period.

In a second embodiment, a medication container includes a medication tray, a lid, a sensor, and processor operably coupled to the sensor. The medication tray includes dividers configured to separate a plurality of storage compartments. The lid is coupled to the medication tray. The lid is configured to detect an interaction with the lid in relation to the medication tray. The processor is configured to determine that a medication consumption period is active. The processor is also configured to determine that the sensor has not detected an interaction with the medication storage container during the medication consumption period. The processor is further configured to activate a notification based on not detecting an interaction with the medication storage container during the medication consumption period.

In a third embodiment, a medication organizer includes a housing, a sensor and a processor operably coupled to the sensor. The housing is configured to store separately packaged medication. The sensor is configured to detect an interaction with the separately packaged medication in relation to the housing. The processor is configured to determine that a medication consumption period is active. The processor is also configured to determine that the sensor has not detected an interaction with the medication storage container during the medication consumption period. The processor is further configured to activate a notification based on not detecting an interaction with the medication storage container during the medication consumption period.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example medication management system in accordance with this disclosure;

FIGS. 2A through 2D illustrate an example medication organizer in accordance with this disclosure;

FIGS. 3A and 3B illustrate an example medication tray in accordance with this disclosure;

FIGS. 4A through 4D illustrate an example lid in accordance with this disclosure;

FIGS. 5A through 5C illustrate an example lid circuitry in accordance with this disclosure;

FIGS. 6A through 6F illustrate example user interfaces in accordance with this disclosure;

FIG. 7 illustrates an example device for a medication management system in accordance with this disclosure; and

FIGS. 8A through 8C illustrate an example medication storage container in accordance with this disclosure.

### DETAILED DESCRIPTION

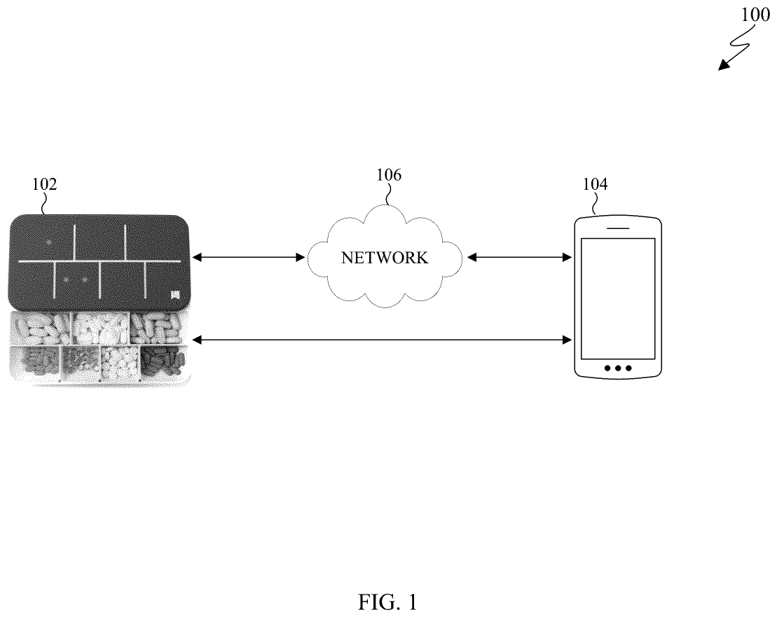

FIGS. 1 through 8C, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

Organizing medication in current medication organizers has a high probability of error due to user error in placing medication in storage compartments, tracking specified storage compartments for consumption and refills, and consuming medication at correct days and time of day. When the medication organizer includes multiple storage compartments, each potentially holding multiple types of medication, organization of the medication organizer can be confusing, which may result in errors.

FIG. 1 illustrates an example medication management system 100 in accordance with this disclosure. The embodiment of the medication management system 100 illustrated in FIG. 1 is for illustration only. FIG. 1 does not limit the scope of this disclosure to any particular implementation of a medication management system.

As shown in FIG. 1, the medication management system 100 can enhance medication management by increasing usability and simplifying sorting and tracking of medication. The medication management system 100 can connect medication organizer 102 to a user device 104 over a network 106.

The user device 104 can include a computing device such as a processor, a logic system, a software control system, a smartphone, a tablet, a computer, or any other device that has the capability to communicate with and process information for the medication organizer 102. The user device 104 can include also any other device that has a Bluetooth or Wi-Fi capabilities, where data can be input into an application loaded onto the user device 104 and sent to the medication organizer 102.

The user device 104 can send and receive data with the medication organizer 102. The user device 104 can control and provide features such as allowing user to order refills through the app, notifying patient and caregiver when it is time to take medication, and gathering data from medication organizer in order to create valuable reports.

The network 106 can be a wired or wireless network. The network 106 can be a public or private network. The medication organizer 102 and the user equipment can communicate over the network 106. The user device 104 can also directly connect to the medication organizer 102 by any wireless or wired connectivity including Wi-Fi, Bluetooth, cellular, or another wireless means for communication with and control of the system operations.

The medication organizer 102 can receive data from a smart phone, tablet, or computer via Bluetooth or a Wi-Fi connection. Received information is stored in a memory or data storage of the medication organizer 102. Once the information is stored in the medication organizer 102, the Wi-Fi or Bluetooth connection is no longer necessary for the specific data transmission but can be maintained for other purposes.

Although FIG. 1 illustrates an example medication management system 100, various changes may be made to FIG. 1. For example, the number and placement of various components of the medication management system 100 can vary as needed or desired, such as having multiple medication organizers 102 connected to a user device 104 or a medication organizer 102 connected to more than one user device 104.

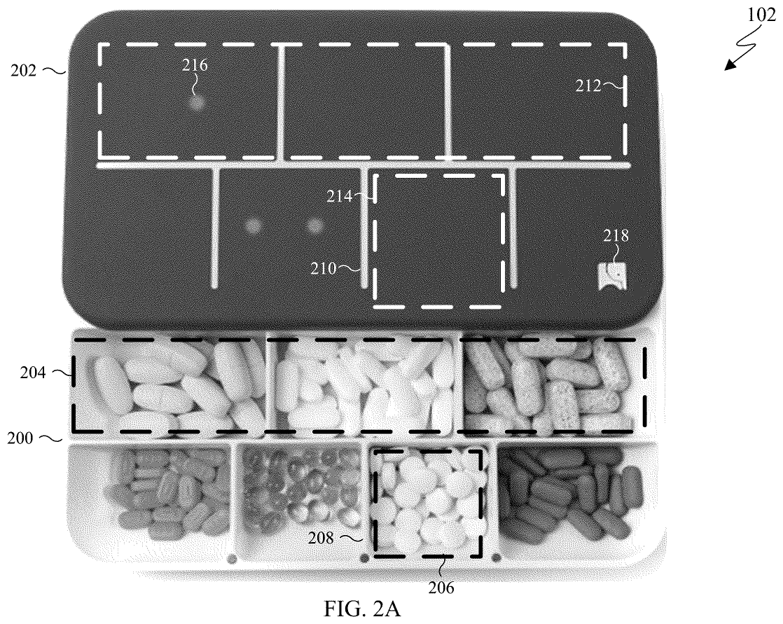

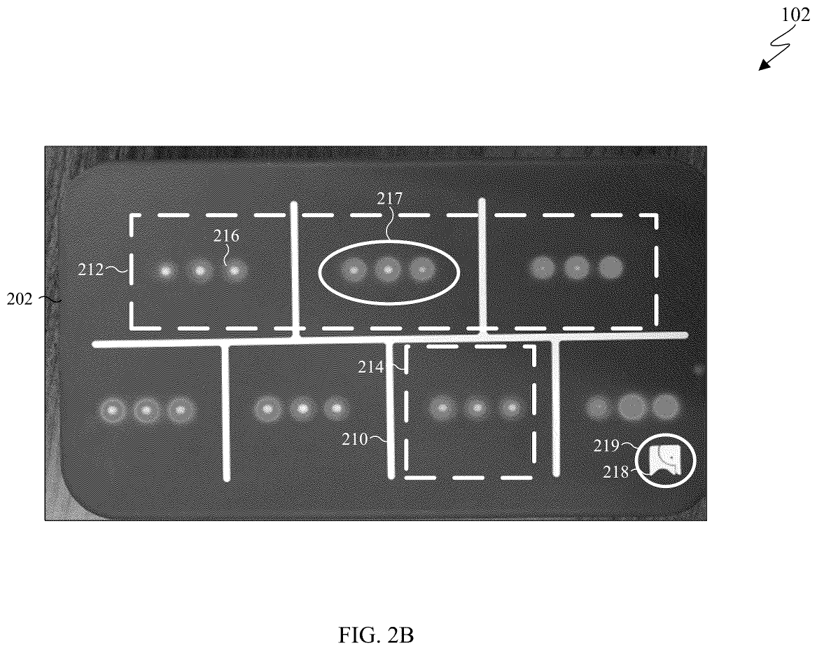

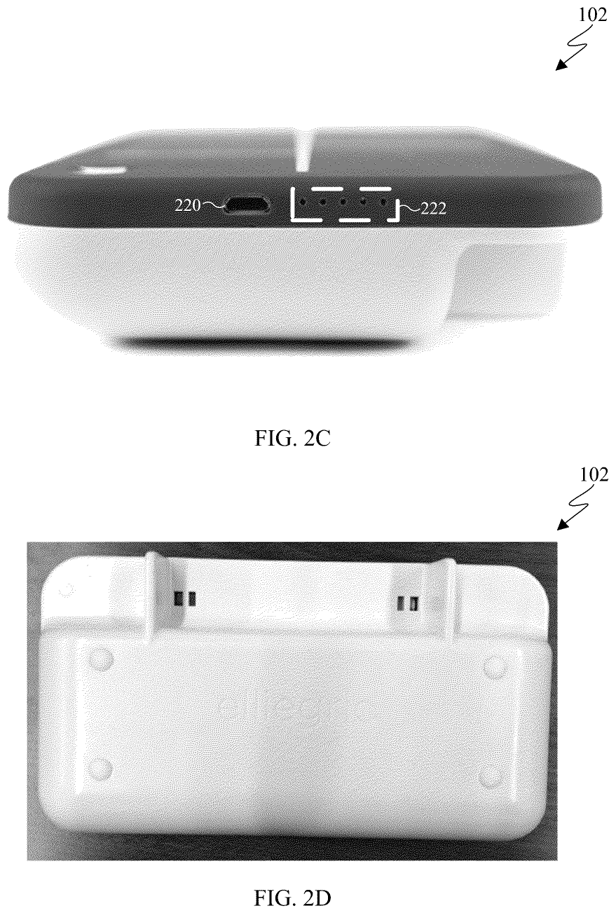

FIGS. 2A through 2D illustrate an example medication organizer 102 in accordance with this disclosure. In particular, FIG. 2A illustrates an opened medication organizer 102, FIG. 2B illustrates a closed medication organizer 102, FIG. 2C illustrates an end view of an example medication organizer 102 and FIG. 2D illustrates a bottom view of an example medication organizer 102. The embodiments of the medication organizer 102 illustrated in FIGS. 2A through 2D are for illustration only. FIGS. 2A through 2D do not limit the scope of this disclosure to any particular implementation of a medication organizer.

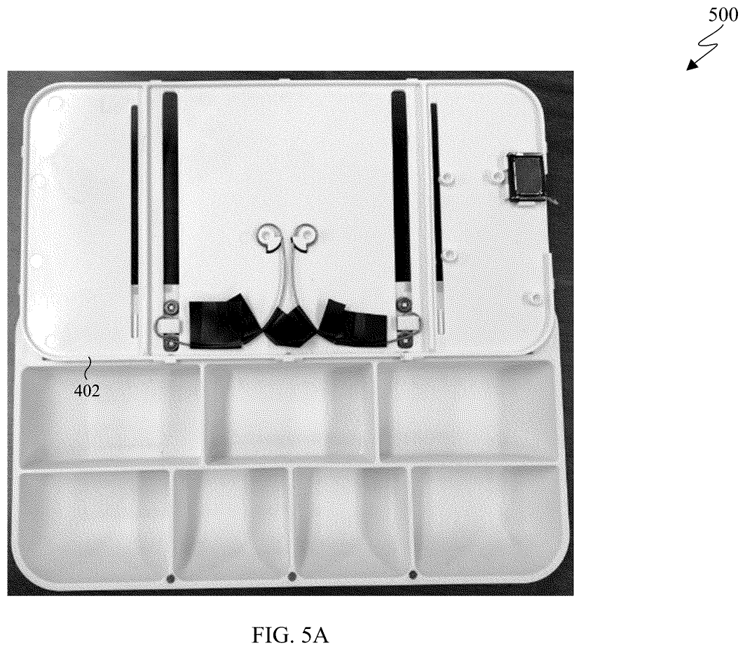

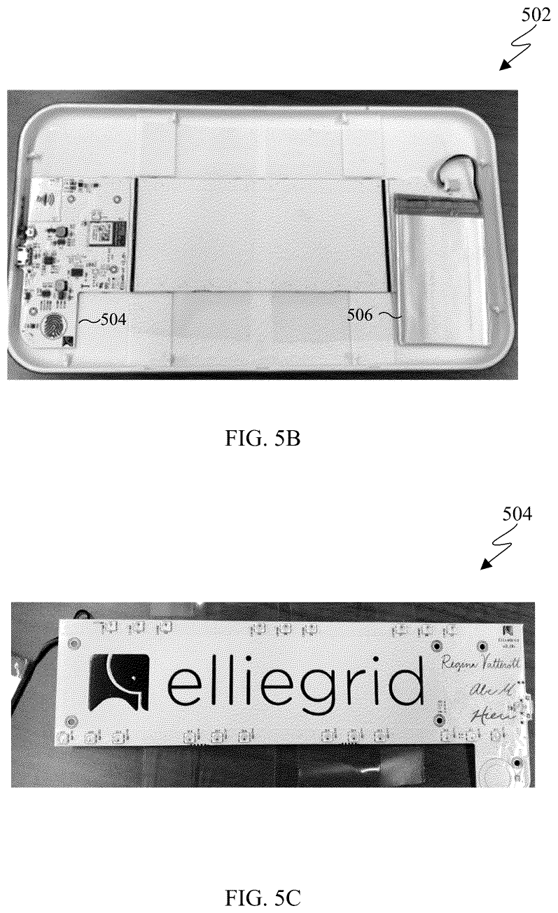

As shown in FIGS. 2A through 2D, medication organizer 102 can hold multiple amounts of multiple, different medications. The medication organizer 102 can include a medication tray 200 and a lid 202. The medication organizer 102 can also include electronic components shown in FIGS. 5A through 5C.

The medication tray 200 can be divided into storage rows 204 and storage compartments 206 within each storage row 204 using physical dividers 208. The medication tray 200 can contain multiple storage compartments 206 that can vary in size and shape. While shown as having two storage rows 204 and seven storage compartments 206 in FIG. 2A, the medication tray 200 can have more or less than two storage rows 204 and more or less than seven storage compartments 206. Each storage row 204 can have a different amount of storage compartments 206 from other storage row. In the illustrative example of FIG. 2A, the top storage row 204 has three storage compartments 206 and the bottom storage row 204 has four storage compartments 206. The storage compartments 206 can be similarly sized, similarly sized based on storage row 204, sized differently based on storage row 204, and sized differently within a storage row 204. Each storage compartment 206 is separated from adjacent storage compartment 206 by dividers 208. The dividers 208 can extend from a bottom surface of the medication tray 200 to a height at or slightly below the outer shell of the medication tray 200.

The lid 202 can be movably coupled with the medication tray 200. The lid 202 can have a sliding mechanism to slide the lid 202 to and from covering the storage compartments 206 of the medication tray 200. In some embodiments, the lid 202 can connect to the medication tray 200 using a hinge. In some embodiments, the lid 202 is fitted around an outer edge of the medication tray and separable from the medication tray 200.

The lid 202 can interactively help manage medication organizer 102. Information can be presented to the user, such as filling instructions, consuming instructions, etc. The lid 202 can include a display or LEDs that can provide information to the user of the medication organizer 102. The lid 202 can include divider markings 210 that correspond to the dividers 208 in the medication tray 200. The divider markings 210 can be paint, tape, LEDs, line on a display, or any other suitable manner of presenting markers corresponding to the dividers 208. The divider markings 210 can separate portions of the lid 202 into row displays 212 and compartment displays 214. A row display 212 can correspond to the storage row 204 and a compartment display 214 corresponds to the storage compartment 206, which allows for the row displays 212 and compartment displays 214 to help provide useful information to the user. For instance, the compartment displays 214 can indicate which compartment 206 to fill with a specific medication, which compartment 206 to consume medication from, an amount of medication from a specified compartment 206, or any other suitable information for managing a medication organizer 102.

The lid 202 can include a plurality of indicators 216 and 218. The compartment and organizer indicators 216 and 218 can be information on a display or LEDs. The compartment and organizer indicators 216 and 218 can be solidly lit, flash in a specified, random, or constant sequence, change colors in a specified or random sequence, or any other suitable method to indicate information. The compartment indicators 216 can be positioned within row displays 212 and/or compartment displays 214. The compartment indicators 216 can be utilized to indicate information to the user specific to a row 204 or compartment 206. For example, when filling a compartment 206, compartment indicators 216 within a corresponding compartment display 214 can be activated. In certain embodiments, multiple compartment indicators 216 are positioned within each of the compartment displays 214. The multiple compartment indicators 216 can be activated all at once, one at a time, or multiple at a time. The multiple compartment indicators 216 can activate in a pattern, randomly, change colors, or any other suitable method of jointly communicating information to a user.

The indicator(s) 218 can be positioned on the lid 202 outside of the row displays 212 and compartment displays 214. The indicator(s) 218 can present information related to a compartment 206 or unrelated to a compartment 206. For example, the organizer indicators 218 can indicate battery level statuses, power status, or any other suitable status of the medication organizer 102. The organizer indicators 218 can also indicate secondary information to related to a compartment 206. For example, the organizer indicator 218 can be a display screen and show a picture of the medication corresponding to the currently activated compartment indicators 216. For example, compartment and organizer indicators 216 can indicate an amount of medication to pull from a specific compartment 206 and the organizer indicator 218 can display one or more of a size, a shape, a color of the medication in the specified compartment 206. This allows for a user to have extra confidence that the correct medication is being consumed or provided to a compartment when filling. While the organizer indicator 218 is located within an area of a compartment display 214, an organizer indicator 218 can be located in another compartment display 214 and the organizer indicator 218 could be used with the compartment display 214 is providing information. In certain embodiments, two medications can be filled in a single compartment 206. The first and organizer indicators 218 can both be used in order to display both of the medications to be filled in or consumed from the single compartment 206. This combination of compartment and organizer indicators 216 and 218 can be useful for providing proper information for the comfort of the user. The combination of compartment and organizer indicators 216 and 218 can indicate when a medication is low and needs to be refilled or reordered and when a medication is fully consumed.

The lid 202 can also include one or more inputs 217 and 219. The inputs can be buttons, switches, toggles, touchscreen, etc. The inputs 217 and 219 can be formed under a portion of the surface of the lid 202 to blend in with the aesthetics of the medication organizer 102. The indicators 216 and 218 can be positioned over or proximately to inputs 217 and 219. The compartment inputs 217 can be utilized for acknowledging pills removed from a specified compartment. For example, when two compartment indicators 216 are lit up, the compartment input 217 can be activated for each corresponding compartment indicator 216 or once for all corresponding compartment indicators 216. In certain embodiments, an organizer input 219 can activated to acknowledge all compartment indicators 216 has been satisfied. The compartment inputs 217 can also be activated to acknowledge a medication has been filled in a corresponding storage compartment 206 or to indicate to the medication organizer 102 which compartment 206 that the medication is filled in. For example, when the medication is filled in an incorrect compartment 206, the user can activate the compartment input 217 corresponding to the incorrectly filled compartment 206. The medication organizer 102 can store this new information and transmit the information to the user device 104. The organizer input 219 can be activated for silencing alarms, muting audio, or any other function of the medication organizer 102.

In certain embodiments, medication can be organized in the storage compartments 206 by medication type in the medication organizer 102, not by a time of day a medication needs to be taken. While some embodiments have a single medication per storage compartment, each storage compartment 206 can store one or more medications. In a medication organizer 102, some of the storage compartments 206 can hold a single medication and other compartments 206 can hold multiple medications. This allows patients to simply pour a medication bottle into a storage compartment 206 instead of having to take the pills from a bottle and individually place them into separate storage compartments 206. In further embodiments, there is one or more compartment indicators 216 on each storage compartment display 214 that indicates a particular medication(s) that is supposed to be inside of the corresponding storage compartment 206.

When it is time to take a medication a light near, on, or within the storage compartment 206 that contains the required medication can light up, or alternatively an alarm can ring, and/or the patient and/or caretaker can receive an alert message through the user device 104.

In certain embodiments, when the storage compartment indicators 216 illuminate, a color of the light can convey how many medications to take out of that storage compartment. For example, when the color of the compartment indicator 216 refers to a number of pills needed from a storage compartment 206. For example, the colors could be set up where a white light represents one pill, a blue light represents two pills and a red light represents no pills, etc.

In other embodiments, the storage compartment display 214 can have lights arranged in the shape of numbers so that the lights can illuminate in the shape of a number that represents how many medications are required from the indicated storage compartment 206.

The information sent to the medication organizer 102 can allow the medication organizer 102 to recognize when specific storage compartment displays 214 should be illuminated and/or when an alarm is to be sounded.

In other embodiments, the medication organizer 102 further comprises a clock to assist users and ensure the timer on the device is set correctly. In certain embodiments, the medication organizer 102 can also have one or more buttons that allow a user to change a time on the clock. The medication organizer 102 also has the ability to recognize when the medication has been removed, and to turn off the lights and/or the alarm once after medication removal. For example, the medication organizer 102 can have a camera that monitors the compartments 206, one or more weight sensors that can detect a weight in each storage compartment 206, or any other suitable method for determining an amount or emptiness of one or more compartments 206.

Additional lights may be put on a PCB that is along the bottom of the medication organizer 102 instead of on light strips. The lights may also on the top rim of each storage compartment 206 instead of below the storage compartments 206.

In certain embodiments, there may also be a space in the corner of each storage compartment 206 where a number can be illuminated so that user knows how many medications to take. There also may be a space in the corner of each storage compartment 206 where the user can write a name of the medication with a pen.

The medication organizer 102 may also not contain a shell for the tray to be placed on. If the medication organizer 102 does not have a shell, the tray would be attached directly to the electronics housing. In this case, the lights would be placed in the tray, instead of below it and on the shell.

As shown in the example embodiment of FIGS. 2A through 2D, the shell can be made of a flat rectangular surface having four wall surfaces located along four corresponding edges of the rectangle. As also seen in FIGS. 2A through 2D, the shell may also have an array of lights disposed on the surface facing up. In certain embodiments, electronics can fit within the lid, and the lid is attached at the head of the shell.

In certain embodiments, the tray further comprises a plurality of small storage compartments in which medications are stored. In certain embodiments, the medication tray 200 can be placed inside of a shell and can be disposed above the lights. The medication tray 200 can be formed from a translucent material, so that when the lights beneath it turn on, light can shine through portions of the medication tray 200.

As certain embodiments, the medication tray 200 are walls disposed in a manner that, when the tray is placed on the shell, the walls fit between light strips in order to keep light from bleeding between storage compartments 206.

Lights do not necessarily cover an entire surface of the shell. Instead, lights may be placed in locations where, when the tray is placed on the shell, the lights fit between the light barrier and the walls of each storage compartment 206. Since the lights may not shine through some medications, the lights may instead shine along a side of each storage compartment 206 so that the light can then shine through the walls of the storage compartments 206.

In certain embodiments, the lights are variably disposed in order to enhance the utility of the system. For example, one or more lights are disposed near or within the medication trays 200; on, near, within or structurally integral with the lid; and/or various other combinations and configurations thereof that can readily occur to an ordinarily skilled artisan. In certain embodiments, light barriers may also have reflective properties so that light can be reflected onto the wall of each storage compartment 206.

In certain embodiments, the medication management system 100 may function as follows: when it is time to take a specific medicine, the lights disposed under the storage compartments 206 containing the required medication may light up. The lights are programmed by the user with a mobile app that sends the information to a microprocessor inside of the medication organizer 102 via low energy Bluetooth or any other suitable wireless connection, whether presently known or future devised. Since the lights may not be integrated into the medication tray 200, the medication trays 200 can be easily interchangeable, thereby allowing medication organizers 102 to be made and sold with different sized medication trays 200 and/or different sized storage compartments 206. The interchangeable medication trays 200 could also be made and sold separately.

In further embodiments, storage compartments 206 of any size and shape can be employed, so long as they illuminate whenever the lights are triggered. These storage compartments 206 can be separate or connected; for example, packaging boxes, folders, drawers, rooms, or any place where objects may be stored.

The storage compartments 206 may be triggered by an alarm in the storage compartment 206 or by an app via Bluetooth, WiFi, or cellular connection. These storage compartments 206 can be programmed on the storage compartment 206, the lid 202, or on a separate user device 104 and then sent to the storage compartments via Bluetooth, WiFi, cellular connection, or any other suitable wired or wireless connection.

The technology may also be used beyond the context of storing medication. For example, a user storing items such as clothes, pictures, or tools in boxes before putting the boxes into storage may store their belongings as desired in a box; record what has been stored in each box on a software application; and then later, whenever the user wants to find a particular stored object, the user need only select the item from its stored item menu, and the box with that object can light up.

Those of skill in the art can appreciate that the system may comprise a single structure of any shape with storage compartments of any shape. In general (though not always), each storage compartment has lights associated with it that are triggered by an alarm, app or the like. The systems may be configured in contemplation of medication management, or as suggested above, for any other similar object storage and identification application.

Medications may also be stored within storage compartments 206 sorted by the type of medications, rather than the time of day and the specific medication required.

The design of the app and the way it interacts with the medication organizer 102 makes it extremely easy to program the medication organizer 102. For example, when a user is adding a new medication into a storage compartment 206, the app can be opened to a page in which there is a grid with the same amount of compartments displayed as the medication organizer 102 has storage compartments 206. The display shapes are similar to the shapes of the storage compartments 206.

The user can press the storage display on the app that corresponds to the storage compartment 206 on the medication organizer 102. When the compartment display is pressed, the corresponding storage compartment 206 can light up on the medication organizer 102 so that the user can be sure the storage compartment 206 in which the medicine is deposited is the same storage compartment 206 being programmed.

In certain embodiments, when the user chooses a number of pills required to be taken, the light can shine in the storage compartment 206 and can turn a color corresponding with the number of pills chosen.

When the information about the medication going into the storage compartment 206 is submitted, the information can be sent and stored in the medication organizer 102. The medication organizer 102 may no longer need to be connected to the application once the data has been sent and stored.

As shown in FIG. 2C, the medication organizer 102 can also include connection ports 220 and audio output holes, which will be referred to as audio output 222. The connection ports 220 and audio output 222 can be positioned on any surface of the lid 202. The connection ports 220 can be on a same surface of the lid 202 as the audio output 222 as shown in FIG. 2C or on different surfaces of the lid 202.

The connection ports 220 can receive a wired connector, such as a USB cable or any other suitable wired connection. The connection ports 220 can be used for charging electronic components of the medication organizer 102, such as the compartment indicators 216 and the organizer indicator 218. The compartment indicators 216 can be used to indicate a charging level. The plurality of compartment indicators 216 can light up or change colors based on a charging level. For example, when 30% of a battery is charged, 30% of the compartment indicators 216 can be lit while the remaining are unlit or 30% the lights can be a first color, such as green, while the remaining lights are a second color, such as red. That way, the user can see that the battery charging is ongoing until all the lights are green and/or lit or not lit. The organizer indicator 218 can indicate a fully charged medication organizer 102 by lighting up or changing colors. In certain embodiments, the combination of compartment indicators 216 and organizer indicators 218 can be used to indicate charge level. For example, the organizer indictor 218 can be a first color, such as red, when the medication organizer 102 has a low charging level and need to be charged, can be a second color, such as green, when the charging is occurring, and a third color, such as blue, when the charging is completed.

The connection port 220 can also be used to transfer or receive data with a user device 104. The user device 104 can transfer information related to amounts and time of medication disbursement through the connection port 220 to the electronics of the medication organizer 102. Examples of information can include amount of dosage and location for a medication, an image of a medication, an amount of medication in a specified storage compartment 206, a time of day for a medication, or any other suitable medication information for managing medication in the medication organizer 102. The compartment and organizer indicators 216 and 218 can be used to indicate data transmission. The compartment indicators 216 can be lit up or change color based on an amount of data transferred. For example, when 50% of information is transferred, half of the compartment indicators 216 can be lit while the remaining are unlit or half the lights can be a first color, such as green, while the remaining lights are a second color, such as red. That way, the user can see that the data transfer is ongoing until all the lights are green and/or lit or not lit. The organizer indicator 218 can indicate an overall data transfer status. For example, the organizer indictor 218 can be a first color, such as yellow or white, while data transfer is ready, can be a second color, such as red, when the data transfer is occurring, and a third color, such as green, when the data transfer is completed.

The audio output 222 can provide audio to assist in managing the medication organizer 102. The audio output 222 can produce a tone, alert, voice, or any other suitable audio output for managing a medication organizer 102. The audio output 222 can output audio that indicates a time for taking medication. An audio output 222 can also include a number of medication or specify a compartment to remove medication. The audio output 222 can work in combination with the compartment and organizer indicators 216 and 218. The audio output 222 can provide audio indications related to medication fills, medication consumption, medication reorders, time of day, battery level, data transfer, etc.

Although FIGS. 2A through 2D illustrate an example medication organizer 102, various changes may be made to FIGS. 2A through 2D. For example, the sizes, shapes, and dimensions of the medication organizer 102 and their individual components can vary as needed or desired.

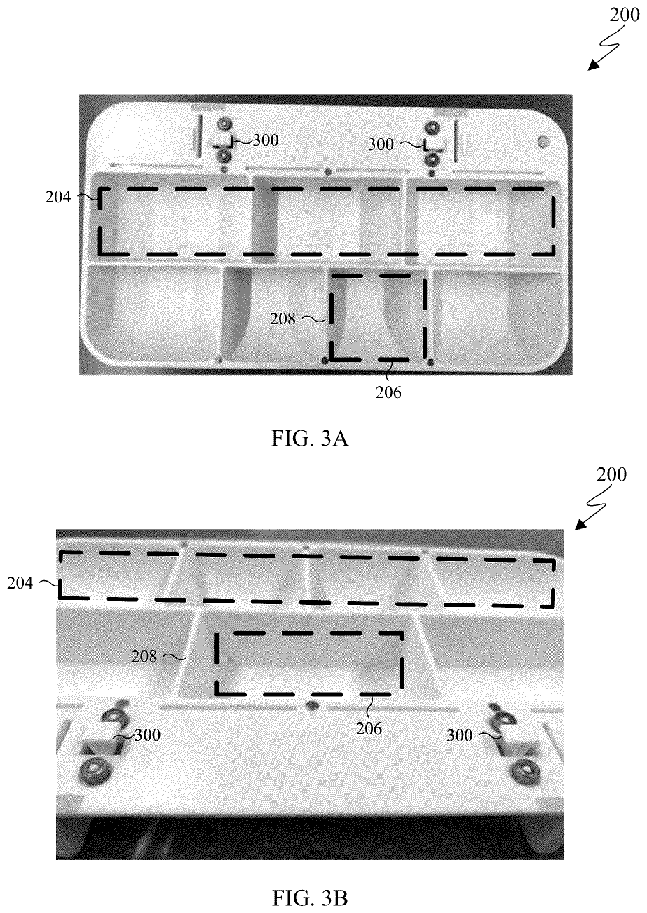

FIGS. 3A and 3B illustrate example medication tray 200 in accordance with this disclosure. In particular, FIG. 3A illustrates lid 202 removed from the medication tray 200 and FIG. 3B illustrates an angled view of medication tray 200. The embodiments of the medication tray 200 illustrated in FIGS. 3A and 3B are for illustration only. FIGS. 3A and 3B do not limit the scope of this disclosure to any particular implementation of a medication organizer 102.

As shown in FIGS. 3A and 3B, the medication tray 200 can be divided into storage rows 204 and storage compartments 206 within each storage row 204 using physical dividers 208. The medication tray 200 can contain multiple storage compartments 206 that can vary in size and shape. While shown as having two storage rows 204 and seven storage compartments 206 in FIG. 2A, the medication tray 200 can have more or less than two storage rows 204 and more or less than seven storage compartments 206. Each storage row 204 can have a different amount of storage compartments 206 from other storage row. The top storage row 204 has three storage compartments 206 and the bottom storage row 204 has four storage compartments 206. The storage compartments 206 can be similarly sized, similarly sized based on storage row 204, sized differently based on storage row 204, and sized differently within a storage row 204. Each storage compartment 206 is separated from adjacent storage compartment 206 by dividers 208. The dividers 208 can extend from a bottom surface of the medication tray 200 to a height at or slightly below the outer shell of the medication tray 200.

The dividers 208 can be sloped from the base to a top surface of the medication tray 200, where a thickness of the dividers 208 is greatest at the based of the medication tray 200 and slowly tapers to a top point of the dividers 208 away from the bottom surface of the medication tray 200. This all for a user to access certain shaped medications that may be difficult to grip or pick up at a bottom of a storage compartment 206. The dividers 208 can also have a constant thickness from a base of the medication tray 200 to a top surface of the medication tray 200. In certain embodiments, the dividers 208 can have a sloped thickness in relation to a first storage compartment 206 and a constant thickness in relation to a second storage compartment 206. In other words, the compartments 206 can have at least one sloped divider 208, while the other three dividers or outer walls can be substantially perpendicular for the storage compartment 206.

The medication tray 200 can further include couplers 300. The couplers 300 can be used to attach the lid 202. Examples of couplers can include sliders, hinges, etc. The couplers 300 can be located and designed to open and close an inside of the medication tray 200 using the lid 202. The couplers can also be designed for allowing wires to run from the lid 202 to the medication tray 200.

Although FIGS. 3A and 3B illustrate an example medication tray 200, various changes may be made to FIGS. 3A and 3B. For example, the sizes, shapes, and dimensions of the medication tray 200 and its individual components can vary as needed or desired.

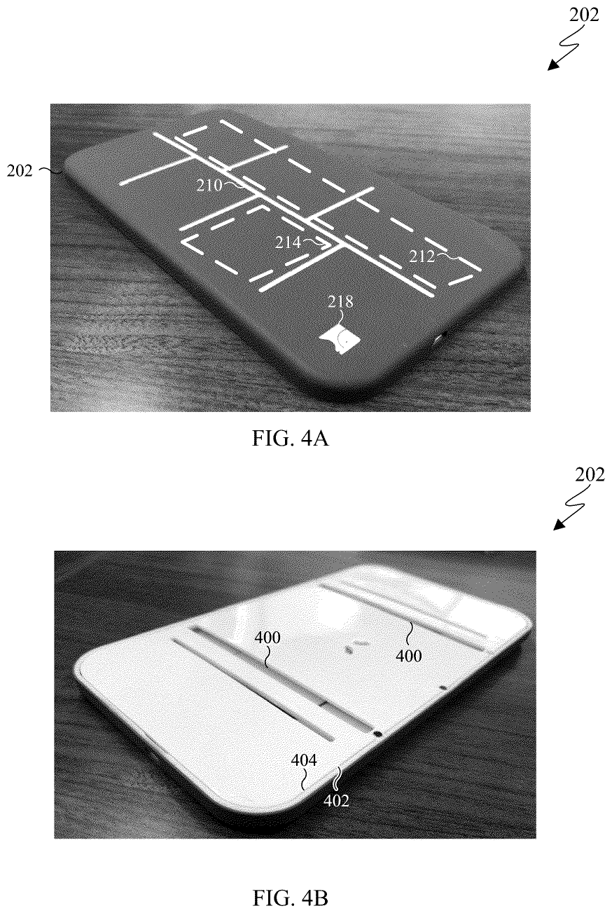

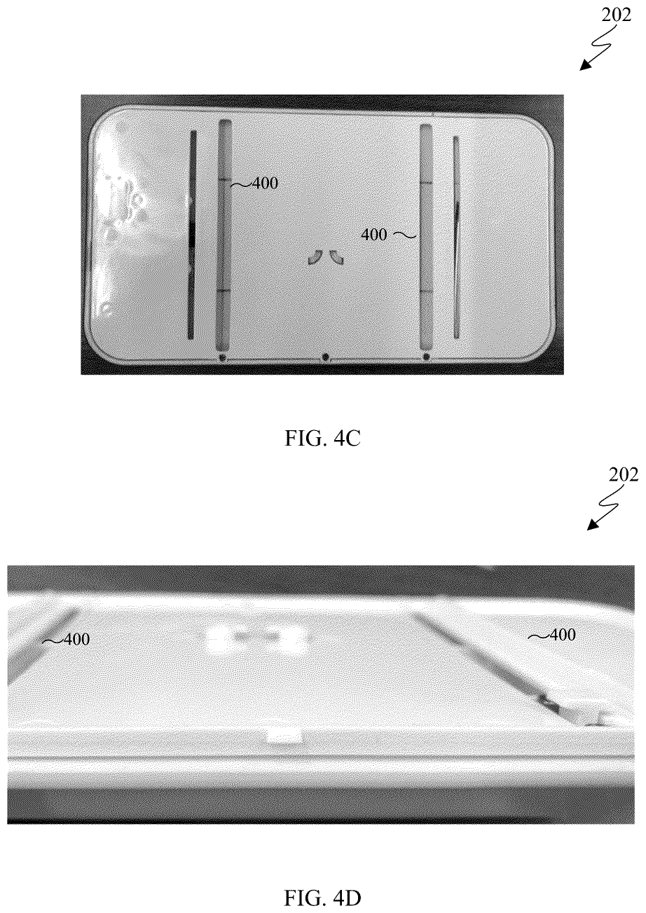

FIGS. 4A through 4D illustrate example lid 202 in accordance with this disclosure. In particular, FIG. 4A illustrates an angled view of the top of the example lid 202, FIG. 4B illustrates an angled view of the bottom of example lid 202, FIG. 4C illustrates a bottom view of the lid 202, and FIG. 4D illustrates a side view of the bottom of lid 202. The embodiments of the lid 202 illustrated in FIGS. 4A through 4D are for illustration only. FIGS. 4A through 4D do not limit the scope of this disclosure to any particular implementation of a medication organizer 102.

As shown in FIGS. 4A through 4D, the lid 202 can be movably coupled with the medication tray 200. The lid 202 can have a sliding mechanism to slide the lid 202 to and from covering the storage compartments 206 of the medication tray 200. In some embodiments, the lid 202 can connect to the medication tray 200 using a hinge. In some embodiments, the lid 202 is fitted around an outer edge of the medication tray and separable from the medication tray 200.

The lid 202 can interactively help manage medication organizer 102. Information can be presented to the user, such as filling instructions, consuming instructions, etc. The lid 202 can include a display or LEDs that can provide information to the user of the medication organizer 102. The lid 202 can include divider markings 210 that correspond to the dividers 208 in the medication tray 200. The divider markings 210 can be paint, tape, LEDs, line on a display, or any other suitable manner of presenting markers corresponding to the dividers 208. The divider markings 210 can separate portions of the lid 202 into row displays 212 and compartment displays 214. A row display 212 can correspond to the storage row 204 and a compartment display 214 corresponds to the storage compartment 206, which allows for the row displays 212 and compartment displays 214 to help provide useful information to the user. For instance, the compartment displays 214 can indicate which compartment 206 to fill with a specific medication, which compartment 206 to consume medication from, an amount of medication from a specified compartment 206, or any other suitable information for managing a medication organizer 102.

The lid 202 can include couplings 400, a bottom cover 402, and an outer shell 404. The couplings 400 can be coupled with the couplers 300 of the medication tray 200 so that the lid 202 can move in relation to the medication tray 200. The lid 202 can be coupled to the medication tray 200 through a sliding mechanism, a hinge, etc. For example, the couplings 400 can couple with the couplers 300 to allow the lid 202 to slide in relation to the medication tray 200. The lid 202 can slide into a closed position so that any medication in the tray 200 is covered and into an open position where the medication in the tray 200 is exposed to an outside of the medication organizer 102. In hinged embodiments or embodiments where the lid 202 can be completely removed, the divider marking 210, row displays 212, and compartment displays 214 along with any of the compartment and organizer indicators 216 and 218 can be positioned on a bottom surface of the lid 202. One or more of the divider marking 210 and compartment and organizer indicators 216 and 218 can be positioned on the bottom cover 402 of the lid 202 or both sides of the lid 202. For example, an organizer indicator 218 can be positioned on both surfaces while the divider marking 210 and compartment indicators 216 may only be positioned on the bottom cover 402 that can be oriented towards the medication tray 200 when in the closed position. This could be useful for embodiments that are wanting the benefits of the divider markings 210 and compartment indicators 216 but do not wish to have them visible when not in use with the lid 202 in the closed position.

Although FIGS. 4A through 4D illustrate an example lid 202, various changes may be made to FIGS. 4A through 4D. For example, the sizes, shapes, and dimensions of the lid 202 and its individual components can vary as needed or desired.

FIGS. 5A through 5C illustrate an example lid interior 500 in accordance with this disclosure. The embodiment of the lid interior 500 illustrated in FIGS. 5A through 5C is for illustration only. FIGS. 5A through 5C does not limit the scope of this disclosure to any particular implementation of a medication organizer. FIG. 5A shows the lid 202 with the outer shell 404 removed, FIG. 5B shows electrical components 502 inside of the outer shell 404, and FIG. 5C shows a reverse side of the circuit board 504.

As shown in FIG. 5A through 5C, an interior 500 of the lid 202 can house electrical components 502 for the medication organizer 102. Various electrical components can be included within the interior of the lid 202 including, for example, a circuit board 504, a battery 506, etc. The circuit board 504 can include memory for storing instructions for operating the compartment indicators 216 and 218, and the audio output 222. The circuit board 504 can also include or be operatively coupled to the connection port(s) 220. The circuit board 504 can be coupled with the battery 506 for powering the circuit board, the compartment and organizer indicators 216 and 218, the audio output 222, and any other suitable electronic components of the medication organizer 102.

Although FIGS. 5A through 5C illustrate an example lid interior 500, various changes may be made to FIG. 5. For example, the number and placement of various components in the lid interior 500 can vary as needed or desired.

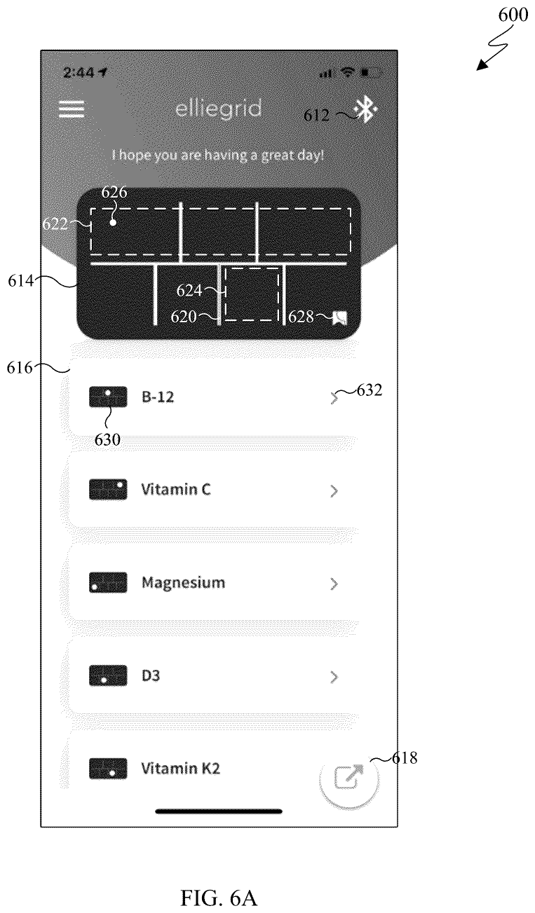

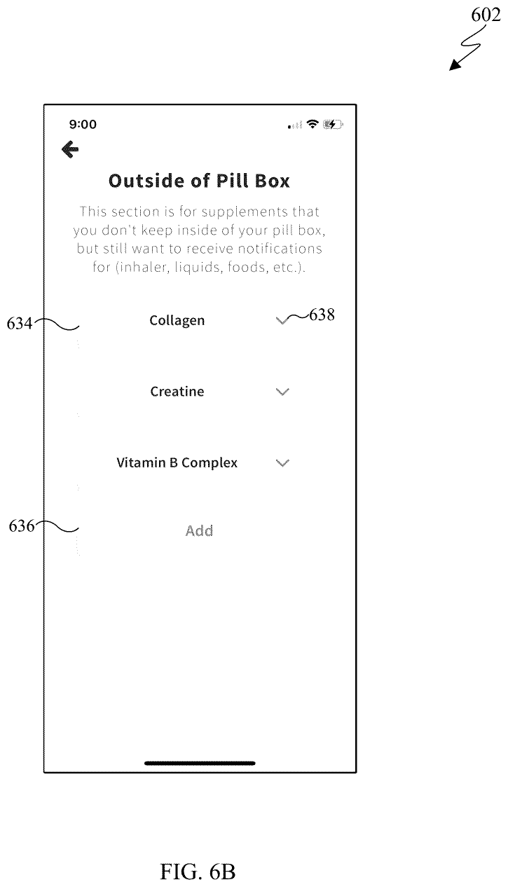

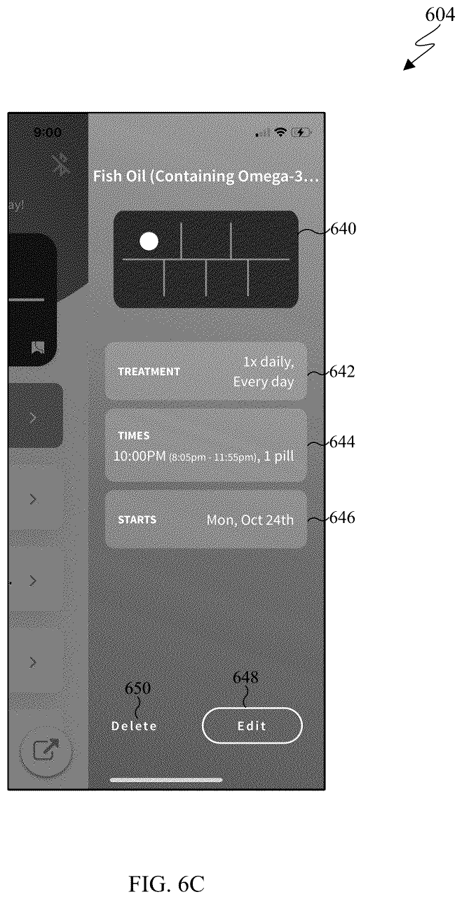

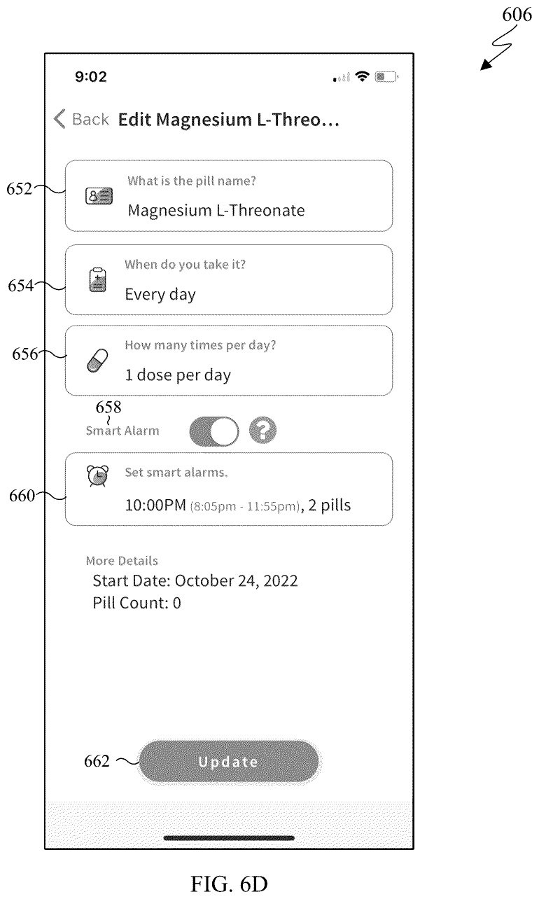

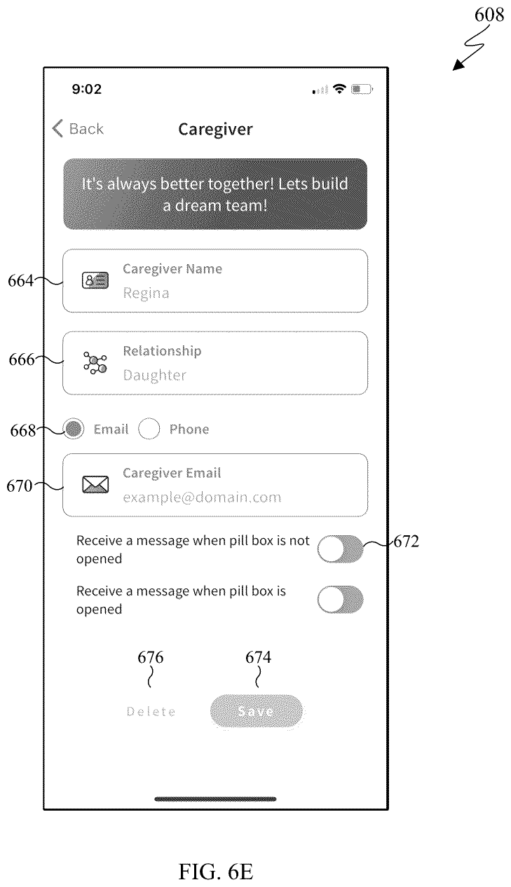

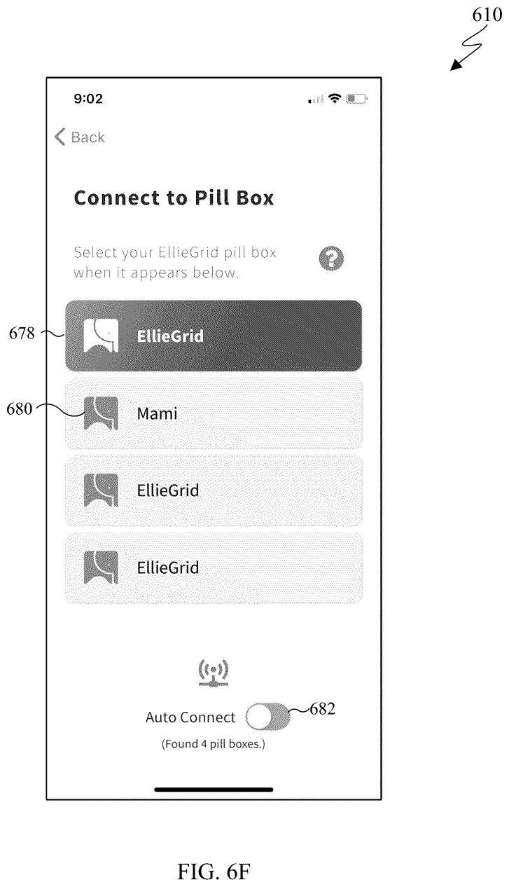

FIGS. 6A through 6F illustrate example user interfaces 600-610 in accordance with this disclosure. The embodiments of the user interfaces 600-610 illustrated in FIGS. 6A through 6F are for illustration only. FIGS. 6A through 6F do not limit the scope of this disclosure to any particular implementation of electronic device. The user interfaces 600-610 can be displayed on the user device 104 to control or display information related to the medication organizer 102.

As shown in FIGS. 6A, user interface 600 can display information related to the organizer 102. The user interface 600 can include status indicators 612, lid display 614, medication information 616, new medication information 618, or any other suitable display information for a medication organizer 102. The user interface 600 can allow for a user equipment to manage the medication organizer 102.

The status indicator 612 can include a connectivity status of the medication organizer 102, an alarm status, a transfer status, a battery level, etc. The status indicator 612 can simplify notifications for displaying on the interface 600 and the user device 104. For example, the status indicator 612 can be activated when the medication organizer 102 is wired or wireless connected to the user device 104. The status indicator 612 can change to a color, such as red, when connectivity issues arise while connecting to the medication organizer 102, can change to a color, such as blue, for indicating an update for the medication organizer 102, can change to a color, such as green, for operating normally, etc.

The lid display 614 can be a digital representation of the lid 202 on the medication organizer 102. The lid display 614 can function similarly and along with the lid 202. The lid display 614 an also work separately and exclusive from a lid 202. The lid display 614 can display indicators 626 and 628. the lid display 614 can interactively help manage medication organizer 102. Information can be presented to the user, such as filling instructions, consuming instructions, etc. The lid display 614 can include information or displays that corresponds to the display or LEDs on the lid 202 that can provide information to the user of the medication organizer 102. The lid display 614 can include divider markings 620 that correspond to divider markings 210 and the dividers 208 in the medication tray 200. The divider markings 620 can separate portions of the lid display 614 into row displays 622 that correspond to the row display 212 and compartment displays 624 that correspond to the compartment display 214. Row displays 622 can correspond to the storage row 204 and a compartment display 624 can correspond to the storage compartment 206, which allows for the row displays 622 and compartment displays 624 to help provide useful information to the user. For instance, the compartment displays 624 can indicate which compartment 206 to fill with a specific medication, which compartment 206 to consume medication from, an amount of medication from a specified compartment 206, or any other suitable information for managing a medication organizer 102.

The lid display 614 can include a plurality of indicators 626 and 628 the respectively correspond to compartment and organizer indicators 216 and 218. The indicators 626 and 628 can be displayed as specified information or icons of LEDs. The indicators 626 and 628 can be solidly lit, flash in a specified, random, or constant sequence, change colors in a specified or random sequence, or any other suitable method to indicate information. The indicators 626 can be positioned within row displays 622 and/or compartment displays 624. The indicators 626 can be utilized to indicate information to the user specific to a row 204 or compartment 206. For example, when filling a compartment 206, indicators 626 within a corresponding compartment display 624 can be displayed. In certain embodiments, multiple indicators 626 can be positioned within each of the compartment displays 624. The multiple indicators 626 can be displayed all at once, one at a time, or multiple at a time. The multiple indicators 626 can be displayed in a pattern, randomly, change colors, or any other suitable method of jointly communicating information to a user. In certain embodiments, the lid display 614 can display more detailed information than the information display on the lid 202. For example, a compartment indicator 216 may only show an amount of medication to be consumed from a specified storage compartment 206, while the indicator 626 can display an image of the medication(s) in the specified compartment 206.

The indicator(s) 628 can be positioned on the lid display 614 outside of the row displays 622 and compartment displays 624. The indicators 628 on the lid display 614 can correspond to an organizer indicator 218 located on the lid 202. The indicator(s) 628 can present information related to a compartment 206 or unrelated to a compartment 206. For example, the indicators 628 can indicate battery level statuses, power status, or any other suitable status of the medication organizer 102. The indicators 628 can also indicate secondary information to related to a compartment 206. For example, the indicator 628 can be a display screen and show a picture of the medication corresponding to the currently activated indicators 626. For example, indicators 626 can indicate an amount of medication to pull from a specific compartment 206 and the indicator 628 can display one or more of a size, a shape, a color of the medication in the specified compartment 206. This allows for a user to have extra confidence that the correct medication is being consumed or provided to a compartment when filling. While the indicator 628 is located within an area of a compartment display 624, a second indicator 628 can be located in another compartment display 624 and the second indicator 628 could be used with the compartment display 624 is providing information. In certain embodiments, two medications can be filled in a single compartment 206. The first and second indicators 628 can both be used in order to display both of the medications to be filled in or consumed from the single compartment 206. This combination of indicators 626 and 628 can be useful for providing proper information for the comfort of the user. The combination of indicators 626 and 628 can indicate when a medication is low and needs to be refilled or reordered and when a medication is fully consumed.

The medication information 616 can display information about a medication managed by the medication management system 100. The medication information can display a name of a medication, a location indicator 630, a more information icon 632, or any other suitable information for a medication or summary of a medication. Examples of other information can include an amount of medication, a time of day for consuming medication, a timer for medication, etc. The location indicator 630 can present information related to a storage compartment 206 that the medication is stored in.

The new medication information 618 can be an icon that allows a user to add a new medication to the medication organizer 102. The new medication information 618 can bring up a scanner that can identify medication by an electronic code on the medication or supplied on paperwork with the medication. The new medication information 618 can also provide the user an option to manually enter medication information including dosages and time of day or amount per day. The new medication information 618 add the new medication as medication information 616 on the user interface 600. The more information icon 632 can be selected for more detailed information related to a specified medication. The more information icon 632 can cause medication interface 604, shown in FIG. 6C, to be displayed. The new medication information 618 can also add medication information for medication stored outside of the medication organizer to be tracked in the application.

As shown in FIG. 6B, user interface 602 can display information related to medications that are stored outside or separately from a medication organizer 102. For example, some medications require refrigeration or other temperature or sunlight requirements. The medications outside of the medication organizer 102 can utilize the indicator 626 and indicator 628 to alert the user for consumption. The medication on interface 602 can also be managed using the audio output 222 on the medication organizer 102. For example, when the time comes for consuming collagen, the audio output 222 can present information directly about the collagen consumption or alert the user to access the interface 602 for the consumption information. The user interface 602 can include outside medication information 634 and new outside medication information 636.

The outside medication information 634 can display information about a medication managed by the medication management system 100 but is not stored within the medication organizer 102. The medication information can display a name of a medication, a more information icon 638, or any other suitable information for a medication or summary of a medication. Examples of other information can include an amount of medication, a time of day for consuming medication, a timer for medication, a storage location (external to the medication organizer 102), etc. The more outside medication information 638 can be an icon that when selected can display the medication interface 604 shown in FIG. 6C for an outside medication.

The new outside medication information 618 can be an icon that allows a user to add a new outside medication to the medication organizer 102. The new outside medication information 618 can bring up a scanner that can identify medication by an electronic code on the medication or supplied on paperwork with the medication. The new medication information 618 can also provide the user an option to manually enter medication information including dosages and time of day or amount per day, storage location, etc. The new outside medication information 618 can add the new medication as outside medication information 634 on the user interface 602.

As shown in FIG. 6C, medication interface 604 can be displayed when the more medication information 632 or the more outside medication information 636 is selected. The medication interface 604 can display medication consumption and location information. In certain embodiments, the medication interface 604 can include location information 640, treatment information 642, time information 644, start treatment information 646, an edit medication icon 648, and a delete medication icon 650

The location information 640 can indicate a storage location of a specified medication being displayed. The location information 640 can display information similar to the location indicator 630 on the user interface 602 or descriptive information for medication stored outside of the medication organizer 102. The treatment information 642 display treatment information for a specified medication. The treatment information 642 can include a daily amount and how often amount. For example, a fish oil pill can be consumed once per day for each day of the week. The time information 644 can display information related to a specified time or time period to consume the specified medication. When a medication is consumed multiple times per day, the time information 644 can display extra rows of the times of day and amounts at those specified times. For example, fish oil should be consumed preferably at 10 pm but within a time range from 9:05 to 10:55. The start treatment information 646 provides information on when to begin the consumption of a specified medication. For example, the fish oil can be set to start consuming on Monday, October 24th.

The user interface 604 can include additional icons for managing the medication consumption information. In certain embodiments, the edit medication icon 648 can be selected to edit any of the medication name, the location information 640, treatment information 642, time information 644, and start treatment information 646. Selecting the edit medication icon 648 can bring up the edit medication user interface 606 shown in FIG. 6D The delete medication icon 650 can be selected to remove the specified medication from the medication management user interface 600. For example, selecting the delete medication icon 650 would remove fish oil from the list of medication information 616 on the user interface 600.

As shown in FIG. 6D, user interface 606 can be displayed when editing medication information 616. The user interface 606 can be displayed as a result of selecting a new medication information 616, new outside medication information 636, or the edit medication icon 648. The user interface 606 can display a name input 652, a consumption time input 654, a consumption daily amount input 656, a smart alarm input 658, a time alarm input 660, and an update icon 662.

The name input 652 allows a user to change a name of a specified medication. The name change could be a complete name change, change to a common name, adding other descriptive information including color or shape of medication, etc. The name input 652 corresponds to the name applied to the medication information 616 or the outside medication information 634.

The consumption time input 654 allows a user to change a timing of medication consumption. The consumption time input 654 could be changed for medication taken daily, weekly, specified days each week, monthly, yearly, etc. For example, the magnesium L-Threonate may be set by default to “taken every day.” If a recommended amount for a specific user could be twice daily, every other day, etc., the consumption time input 654 can adjust the correct information.

The consumption daily amount input 656 allows a user to change an amount of medication per day. The consumption daily amount input 656 can specify 1 dose per day, multiple doses per day, etc. For example, the magnesium L-Threonate may be set by default to have one dose per day but the recommended consumption for a user is two doses per day. The consumption daily amount input 656 can be adjusted to two doses per day.

The smart alarm input 658 and the time alarm input 660 can adjust a smart alarm for the medication organizer 102. The smart alarm input 658 can be a toggle or other type of input for selecting or deselecting the smart alarm functions. The smart alarm input 658 can be toggled on and off based on the user. The smart alarm input 658 can also include a selection for a type of alarm, types of indicators to user for indicating time for medication consumption, etc. For example, the smart alarm input 658 can include an input for controlling the compartment and organizer indicators 216 and 218.

Smart alarms can be used to help people who sometimes have difficulty with regularly taking medication. When programming an alarm for the smart alarm input 658, a user can choose a window of time in which medication can be consumed. In certain embodiments, the smart alarm information can be input by a caregiver or doctor that has been approved to access or update a profile related to the medication organizer.

If a user opens the medication organizer during a medication consumption period, the medication indicators can be activated to indicate an amount of medication to consume from each indicated storage compartment. The act of the opening the medication organizer can deactivate the smart alarm.

In certain embodiments, the medication organizer can include a sensor to detect interactions with the medication organizer. The sensor could be a vibration sensor, a sensor to detect an opening of the lid, a light sensor inside of the medication organizer, or any other sensor that could determine that the medication storage has been accessed or determine that medication has been removed from the medication organizer.

The smart alarm can be customized based on a timing of the medication consumption period. The smart alarm can include one or more indicators for presenting a timing of the medication consumption period. The smart alarm also provides a range of indications for drawing attention of a user when the medication consumption periods is active.

For example, a visual indicator can be activated at a start of a medication consumption period. The visual indicator can be increased as the medication consumption period continued without an opening event of the medication organizer. The visual indicator can change color based on an amount of time remaining. For example, the visual indicator could be activated with a white color at a beginning of the medication consumption period and be changed to a second color, such as green, at one-fourth of the medication time period, a third color, such as blue, halfway through the medication time period, a fourth color, such as yellow, at three-quarters of the medication time period, and a fifth color, such as red, at the close of the medication consumption period.

In certain embodiments, a pattern of lights can be used to indicate a timing of the medication consumption period. For example, a row of indicator can be activated one at a time corresponding to a ratio of time elapsed to a total time. In certain embodiments, the medication organizer can remain silent at a beginning of a medication consumption period. In certain embodiments, the medication organizer can present an increasingly vibrant display using the indicators. For example, the medication organizer can activate the medication organizer indicator when the medication consumption period begins. As the time passes for the medication consumption period, the compartment indicators can be activated to provide a visual effect, such as flashing lights, activating compartment indicators in an increasing amount, etc.

The smart alarm can also use the audio output of the medication organizer to indicate the medication consumption window. For example, the smart alarm can cause the medication organizer to output a tone at the beginning of the medication consumption period. Additional tones can be set to be output from the medication organizer based on a frequency, a ratio of time lapse to total time, etc. The tone can be increased in volume as the time passes through the medication consumption period. The medication organizer can also increase a length of a tone as the time passes through the medication consumption period. The audio output can also use a pre-recorded voice or a simulated voice to present information. For example, the audio output could output “medication consumption period is open” and “medication consumption period is closed.”

In certain embodiments, the smart alarm can determine that a medication consumption period is active. The medication consumption period is a time period in which medication stored in the medication organizer can be consumed. Each medication can correspond to one or more medication consumption periods. Also, each medication organizer can include one or more medication consumption periods. The medication consumption period can correspond to the time information 644.

The smart alarm can determine a sensor on the medication organizer has not detected an interaction with the medication storage container during the medication consumption period. When an alarm or notification is scheduled, the smart alarm can determine whether the medication organizer has been interacted with in a manner that would suggest the specified medication is consumed. For example, the sensor could determine the lid has been opened or that medication has been removed.

Any alert or notifications related to the medication consumption period of the smart alarm could be controlled based on the status of detected interaction with the medication organizer. As long as no interactions that would indicate medicine consumption have occurred, the alerts or notifications could be activated. The alarms and notifications can be discrete, repetitive, continuous, etc. For alarms and notifications that repeat, extended, or continuous, can be deactivated upon detecting an interaction with the medication organizer. Future schedule alerts or notifications can be cleared once an interaction with the medication organizer has been detected within the medication consumption period. For example, a notification schedule for halfway through the medication consumption period can be cleared when an interaction is detected prior to halfway through the medication consumption period and subsequently not activated based on detecting a prior interaction of the medication organizer.

The medication organizer can indicate when medication has not been consumed during the medication consumption period. The medication organizer can further include a user input for skipping or deactivating the alerts and notification of the smart alarm. The activation of the user input causes an ongoing alerts and notifications to end and can clear any future alerts or notifications for the medication consumption period. The medication organizer can also determine that a medication consumption period has ended without detecting an interaction with the medication organizer. When the medication consumption period is skipped or ends without a detected interaction with the medication organizer, a message can be sent indicating that the medication has not been consumed during the medication consumption period. The message can be sent to a specified third party, such as a family member or healthcare provider. The message can include a reason for determining that the medication has not been consumed, including when the user input is used to skip the medication consumption period and the medication consumption period ends without a detected interaction with the user.

In certain embodiments, a user proximity can be detected for the smart alarm. The smart alarm can control the indicators and the audio output based on detecting a proximity of a user. The medication organizer can output visual effects and audio effects when the user is detected to increase the likelihood of drawing attention from a user or other person that the medication consumption window is open. In certain embodiments, the medication organizer can remain on silent when a user is not detected, regardless of a medication consumption window beginning. This could enhance battery life by not presenting indicators or audio output when a user is not in proximity to notice the indicators or audio output. In certain embodiments, the visual indicator can be used regardless of proximity and the audio output used based on proximity detection. In certain embodiments, the visual indicators and/or audio output can be used in a normally prescribed manner while additional indicator and audio output application would be used when proximity of a user is detected. In certain embodiments, the audio output can be activated normally within a medication consumption period and the visual indicators only used or enhanced when proximity of a user is detected.

The medication organizer can transmit smart alarm information to a user device corresponding to the user. For example, the medication organizer can indicate that a user has not opened the lid at predetermined times and cause the user device to display a notification or alarm on the user equipment. The user equipment can present similar visual and audio alerts as described for the medication organizer. For example, the user device can display an alarm or a virtual medication organizer with the visual effect and audio output by the medication organizer.

In certain embodiments, the smart alarm can be silenced on the medication organizers. Once the smart alarm is silenced, any alerts or indicators are deactivated. The medication organizer can send information of the silenced alarm to the user device or to an external server to record that the medication was not consumed. The information can include, for example, a specific consumption time period, a time the silence occurred within the consumption time period, etc. In certain embodiments, the smart alarm can be silenced using the input 217 and 219, a microphone capturing a specified command, a camera capturing a specified gesture, etc.

The update icon 662 can allow the information changed in the inputs 652-660 to be updated throughout the other interfaces 600-604, 608, and 610. The update icon 662 also can update any related information stored on the medication organizer 102. For instance, selecting the update icon 662 can cause instructions for medication consumption to be transferred to the medication organizer 102. The information can be used to control the compartment and organizer indicators 216 and 128 and the audio output 222.

As shown in FIG. 6E, caregiver edit user interface 608 can be used to authorize or designate a caregiver to access the controls for a medication organizer 102. The caregiver edit user interface 608 can include a caregiver name input 664, a relationship input 666, a contact method input 668, contact information input 670, additional control selections 672, a save changes input 674, and delete caregiver input 676.

The caregiver name input 664 allows a user to designate a caregiver. The caregiver name input 664 can include a name to identify a specified individual for control or access to the medication management system 100 for a user. The caregiver name input 664 can be a formal name or a username for the medication management system 100. For example, a person named “Regina” is shown as a caregiver for a specified user. The caregiver name input 664 can bring up a separate user interface to identify the user. In certain embodiments, the caregiver is not provided access to the medication management system but is included for emergency purposes.

The relationship input 666 indicates a relationship between the user and the caregiver. The relationship can include familial relationship, professional relationship (e.g., nurse), etc. For example, the caregiver “Regina” is designated as a daughter of the user.

The contact method input 668 and the contact information input 670 contain information related to contacting the caregiver. The contact method input 668 can be a preferred method of contacting a specified caregiver and the contact information input 670 can be the actual contact information to use for the specified contact type. In certain embodiments, the contact method input 668 can include multiple contact information inputs 670 and order preferences of each selection. For example, an email and phone number can be included or multiple phone numbers can be included for reaching the specified caregiver.

The additional control selections 672 can be selected for additional controls of information provided to a specified caregiver. Additional control selections can include sending messages when a medication organizer 102 is opened, when a medication organizer 102 is not opened, when an alarm is ignored, etc.

The save changes input 674 updates the information for the caregiver in the medication management system 100. The delete caregiver input 676 removes the caregiver and all associated information from the medication management system 100.

As shown in FIG. 6F, medication organizer unit user interface 610 can allow a user device 104 to connect to multiple medication organizers 102. The user interface 610 can include one or more medication organizer information 678, each including a medication organizer indicator 680, and an auto connect input 682. The user interface 610 allows for a user to easily manage multiple medication organizers 102, which may be important for managing medication for multiple dependents. For example, parents with young children that require medication may have a separate medication organizer 102 for each child. In certain embodiments, a medication organizer 102 can be used for multiple users. For example, when multiple children only require one or two medications specific storage rows 204 or storage compartments 206 can be designated for each child. A specified color can be assigned for each child or each user of the medication organizer 102. The organizer indicator 218 can display a specified color corresponding to a user and the compartment indicator can display a number of medications to be consumed from the specified storage compartment 206. The medication organizer indicator 680 can also match a color displayed on the medication organizer 102 to ensure that the correct medication organizer 102 is being selected for the correct user.

The auto connect input 682 can be selected for each of the one or more medication organizer information 678. When a specified medication organizer information 678 is selected, such as “EllieGrid” medication organizer information 678, the auto connect input 682 can be toggled for the specific medication organizer 102. When none of the medication organizer information 678 are selected, the auto connect input 682 can be globally adjusted.

Although FIGS. 6A through 6F illustrate an example user interfaces 600-610, various changes may be made to FIGS. 6A through 6F. For example, the number and placement of various components of the user interfaces 600-610 can vary as needed or desired.

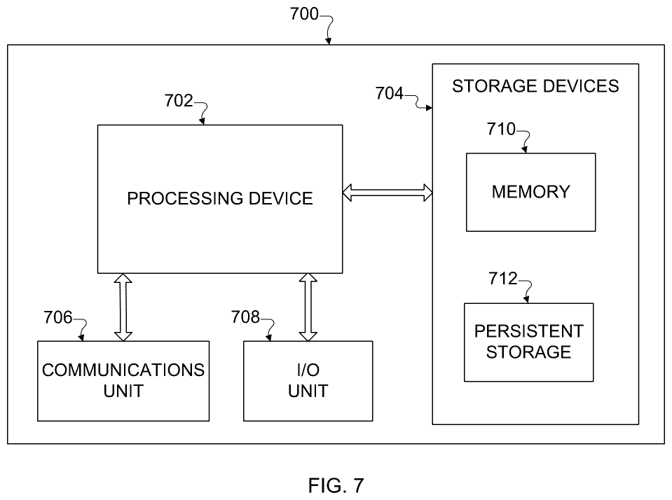

FIG. 7 illustrates an example device 700 for a medication management system according to this disclosure. One or more instances of the device 700 (or portions thereof) may, for example, be used to at least partially implement the functionality of the medication management system 100 of FIG. 1. For example, the device 700 can be used to implement the functionality of the medication organizer 102. However, the functionality of the medication management system 100 may be implemented in any other suitable manner.

As shown in FIG. 7, the device 700 denotes a computing device or system that includes at least one processing device 702, at least one storage device 704, at least one communications unit 706, and at least one input/output (I/O) unit 708. The processing device 702 may execute instructions that can be loaded into a memory 710. The processing device 702 includes any suitable number(s) and type(s) of processors or other devices in any suitable arrangement. Example types of processing devices 702 include one or more microprocessors, microcontrollers, DSPs, ASICs, GPUs, FPGAs, or discrete circuitry.

The processing device 702 can be operably coupled to the compartment indicators 216, organizer indicators 218, and audio output 222. The processing device 702 can activate a compartment indicator in a compartment display corresponding to a storage compartment to fill with a medication. The processing device 702 can also activate an amount of compartment indicators in a compartment display for indicating an amount of medication to consume from a corresponding storage compartment. The processing device 702 can further output an alert using the audio output when the lid has not been opened within a medication consumption period or transmit an alert to a user device when the lid has not been opened within a medication consumption period. Additionally, the processing device 702 can activate the organizer indicator to indicate a medication consumption event and, when the lid adjusted to open the medication organizer 102, activate a compartment indicator on a compartment display corresponding to a medication in a storage compartment. The processing device can further be configured to activate one or more compartment indicators of a compartment display corresponding to a storage compartment that needs to be refilled or is empty.

The memory 710 and a persistent storage 712 are examples of storage devices 704, which represent any structure(s) capable of storing and facilitating retrieval of information (such as data, program code, and/or other suitable information on a temporary or permanent basis). The memory 710 may represent a random access memory or any other suitable volatile or non-volatile storage device(s). The persistent storage 712 may contain one or more components or devices supporting longer-term storage of data, such as a read only memory, hard drive, Flash memory, or optical disc.

The communications unit 706 supports communications with other systems or devices. For example, the communications unit 706 can include a network interface card or a wireless transceiver facilitating communications over a wired or wireless network. The communications unit 706 may support communications through any suitable physical or wireless communication link(s).

The I/O unit 708 allows for input and output of data. For example, the I/O unit 708 may provide a connection for user input through a keyboard, mouse, keypad, touchscreen, or other suitable input device. The I/O unit 708 may also send output to a display or other suitable output device. Note, however, that the I/O unit 708 may be omitted if the device 700 does not require local I/O, such as when the device 700 can be accessed remotely or operated autonomously.

In some embodiments, the instructions executed by the processing device 702 can include instructions that implement all or portions of the functionality of the medication management system 100 described above. For example, the instructions executed by the processing device 702 can include instructions for a medication management system 100 as described above.

Although FIG. 7 illustrates one example of a device 700 for a medication management system 100, various changes may be made to FIG. 7. For example, computing devices and systems come in a wide variety of configurations, and FIG. 7 does not limit this disclosure to any particular computing device or system.

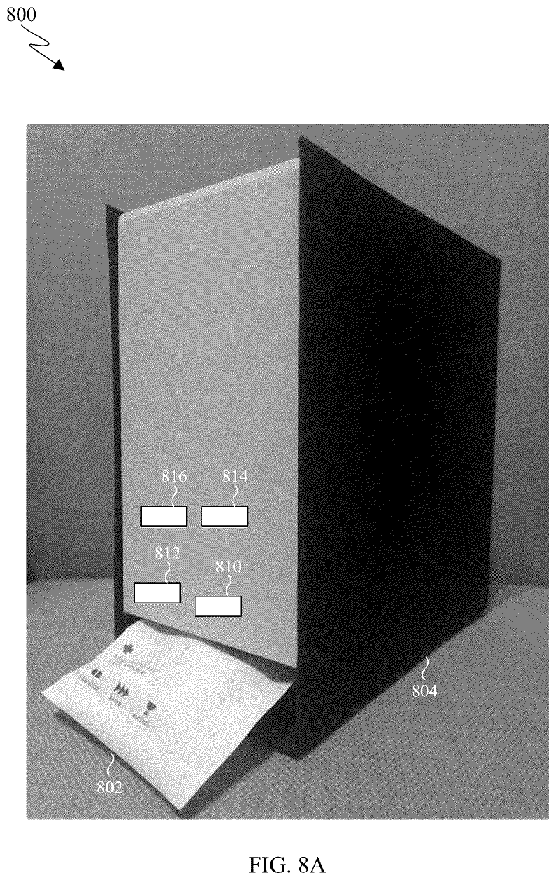

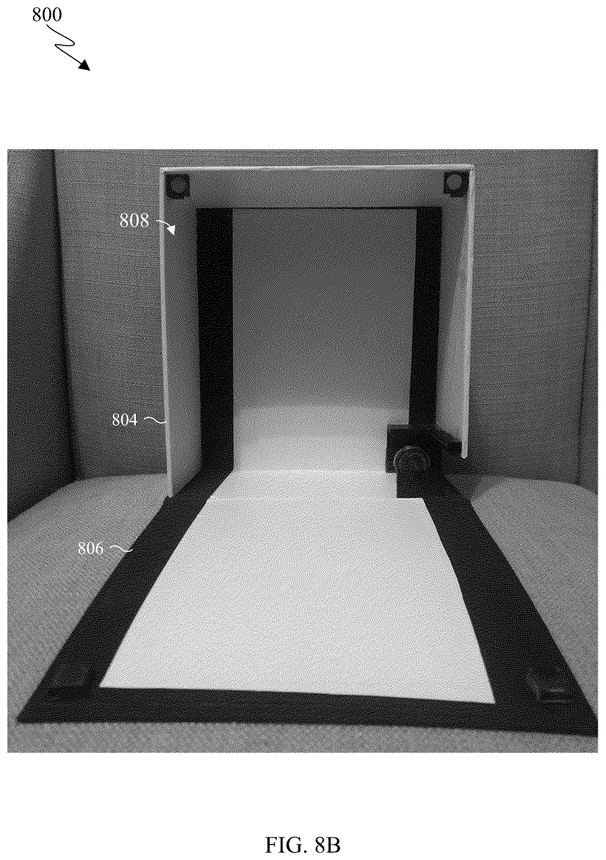

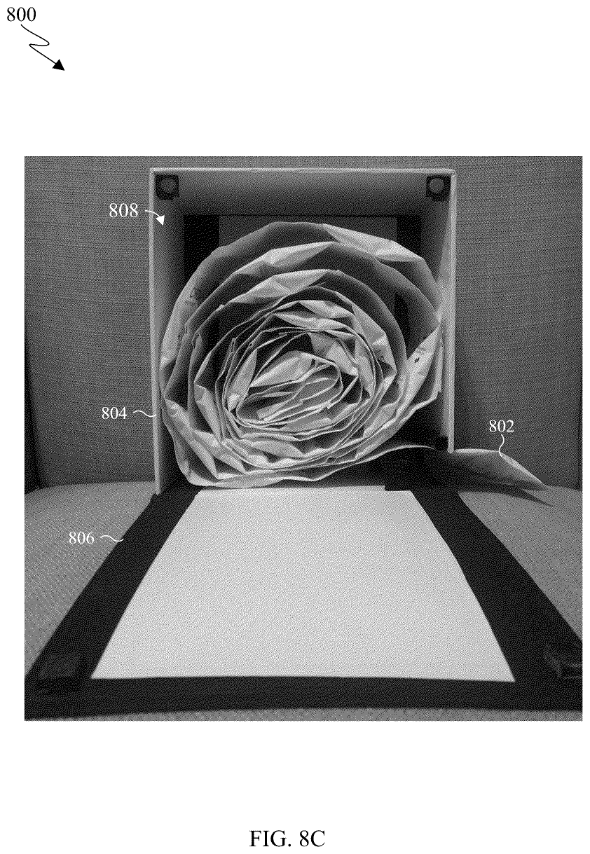

FIGS. 8A through 8C illustrate an example medication storage container 800 in accordance with this disclosure. In particular, FIG. 8A illustrates medication storage container 800 with a medication packet 802, FIG. 8B illustrates an opened medication storage container 800, and FIG. 8C illustrates an opened medication storage container 800 filled with medication packets 802. The embodiments of the medication storage container 800 illustrated in FIGS. 8A through 8C are for illustration only. FIGS. 8A through 8C do not limit the scope of this disclosure to any particular implementation of a medication organizer.

As shown in FIGS. 8A through 8C, medication storage container 800 can hold multiple medication packets 802. The medication storage container 800 can include a medication housing 804 and a lid 806. The medication storage container 800 can also include electronic components shown in FIGS. 5A through 5C.

An interior of the medication housing 804 can be divided into multiple storage compartments using physical dividers. While shown as having a single storage space, the medication housing 804 can have more than one storage space 808.

The lid 806 can be movably coupled with the medication housing 804. The lid 806 can have a sliding mechanism to slide the lid 806 to and from covering the storage space 808. In some embodiments, the lid 806 can connect to the medication housing 804 using a hinge. In some embodiments, the lid 806 is fitted around an outer edge of the medication tray and separable from the medication housing 804.

The medication housing 804 and/or lid 806 can interactively help manage the medication packets 802 stored in the medication storage container 800. Information can be presented to the user, such as filling instructions, consuming instructions, etc. The medication housing 804 and/or lid 806 can include a display or LEDs that can provide information to the user of the medication storage container 800. For instance, the medication display 810 can indicate which medication 802 to fill in the storage space 808, which medication packet 802 to consume medication from, or any other suitable information for managing a medication storage container 800. The medication display 810 can also be located on the lid 806

The medication housing 804 and/or lid 806 can also include one or more inputs 812. The inputs 812 can be buttons, switches, toggles, touchscreen, etc. The inputs 812 can be formed under a portion of the surface of the medication housing 804 and/or lid 806 to blend in with the aesthetics of the medication storage container 800. The display 810 can be positioned over or proximately to inputs 812. The inputs 812 can be utilized for acknowledging pills removed from the medication storage container 800. The medication storage container 800 can store new information and transmit the information to the user device 104. The input 812 can be activated for silencing alarms, muting audio, or any other function of the medication storage container 800.

When it is time to take a medication a light near, on, or within the medication storage container 800, the display 810 can light up, or alternatively an alarm can ring, and/or the patient and/or caretaker can receive an alert message through the user device 104.

In certain embodiments, when the display 810 illuminates, a color of the light can convey how many medications to take out of that storage space 808. For example, when the color of the display 810 refers to a number of pills needed from a storage space 808. For example, the colors could be set up where a white light represents one medication packet 802, a blue light represents two medication packets 802, and a red light represents no medication packets 802, etc.

The information sent to the medication storage container 800 can allow the medication storage container 800 to recognize when the display 810 should be illuminated and/or when an alarm is to be sounded.

In other embodiments, the medication storage container 800 further comprises a clock to assist users and ensure the timer on the device is set correctly. In certain embodiments, the medication storage container 800 can also have one or more buttons that allow a user to change a time on the clock. The medication storage container 800 also has the ability to recognize when the medication has been removed, and to turn off the lights and/or the alarm once after medication removal. For example, the medication storage container 800 can have a camera that monitors the storage space(s) 808, one or more weight sensors that can detect a weight in the storage space 808, or any other suitable method for determining an amount or emptiness of one or more storage spaces 808.

The medication storage container 800 may be triggered by an alarm in the storage space 808 or by an app via Bluetooth or cellular connection. The medication storage container 800 can be programmed on the medication housing 804, the lid 806, or on a separate user device 104 and then sent to the medication storage container 800 via Bluetooth, cellular connection, or any other suitable wired or wireless connection.

The medication storage container 800 can also include connection ports 814 and audio output holes, which will be referred to as audio output 816. The connection ports 814 and audio output 816 can be positioned on any surface of medication housing 804 and/or the lid 806. The connection ports 814 can be on a same surface as the audio output 816 as shown in FIG. 8C or on different surfaces of the medication storage container 800.

The connection ports 814 can receive a wired connector, such as a USB cable or any other suitable wired connection. The connection ports 814 can be used for charging electronic components of the medication storage container 800, such as the display 810. The display 810 can be used to indicate a charging level. The display 810 can light up or change colors based on a charging level. The display 810 can indicate a fully charged medication storage container 800 by lighting up or changing colors. In certain embodiments, the display 810 can be used to indicate charge level. For example, the display 810 can be a first color, such as red, when the medication storage container 800 has a low charging level and need to be charged, can be a second color, such as green, when the charging is occurring, and a third color, such as blue, when the charging is completed.

The audio output 816 can provide audio to assist in managing the medication storage container 800. The audio output 816 can produce a tone, alert, voice, or any other suitable audio output for managing a medication storage container 800. The audio output 816 can output audio that indicates a time for taking medication. An audio output 816 can also include a number of medication packets to remove. The audio output 816 can work in combination with the display 810. The audio output 816 can provide audio indications related to medication fills, medication consumption, medication reorders, time of day, battery level, data transfer, etc.

In certain embodiments, the medication storage container 800 can track an amount of packages removed and adjust future alarms accordingly. The medication storage container 800 can have a counter that increases when a package is removed and decreases when a medication consumption period begins. The counter can also work in the opposite manner where the counter is decreased when a package is removed and increases when the medication period begins. The medication storage container 800 can use the counter to determine whether notifications and/or alarms should be activated based on the counter. The counter can also be incremented at an end of a medication consumption period in the same manner as removing a medication package in order to keep a true count. The medication storage container 800 can perform a check on the counter at a beginning of the medication consumption period to determine whether the counter is zero. If the count is zero, then the notifications and alarms can be set accordingly. If the count is other than zero, the notifications and alarms can be ignored for this medications consumption period. This is useful in circumstances where a use may plan on being away from the medication storage container and removes multiple packages, effectively rendering notifications and alarms for the future medication consumption periods unnecessary.

Although FIGS. 8A through 8C illustrate an example medication storage container 800, various changes may be made to FIGS. 8A through 8C. For example, the sizes, shapes, and dimensions of the medication storage container 800 and their individual components can vary as needed or desired.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A medication storage container comprising:
a sensor configured to detect an interaction with the medication storage container; and
a processor operably coupled to the sensor, the processor configured to:
determine that a medication consumption period is active,
determine that the sensor has not detected an interaction with the medication storage container during the medication consumption period, and
activate a notification based on not detecting an interaction with the medication storage container during the medication consumption period.

2. The medication storage container of claim 1, wherein the processor is further configured to:
detect an interaction with the medication storage container; and
deactivate the notification based on the detected interaction.

3. The medication storage container of claim 1, wherein the processor is further configured to:
detect an interaction with the medication storage container during the medication consumption period; and
clear future notifications scheduled for the medication consumption period.

4. The medication storage container of claim 1, further comprising:
a second sensor configured to detect a user in proximity to the medication storage container,
wherein the processor is operably coupled with the second sensor and is further configured to:
detect a user in proximity of the medication storage container, and
in response to detecting a user in proximity of the medication storage container, activate a second notification based on not detecting an interaction with the medication storage container during the medication consumption period.

5. The medication storage container of claim 1, wherein the interaction with the medication storage container is detecting a position of a lid changes; and
deactivate the notification based on the position of the lid changing.

6. The medication storage container of claim 1, further comprising:
a user input configured to stop the medication consumption period,
wherein the processor is operably coupled to the user input and further configured to transmit a message indicating that the medication consumption period was stopped using the user input.

7. The medication storage container of claim 1, wherein the processor is further configured to:
determine the medication consumption period has ended without detecting an interaction with the medication storage container, and
transmit a message indicating that the medication consumption period has ended without detecting an interaction with the medication storage container.

8. A medication storage container comprising:
a medication tray including dividers configured to separate a plurality of storage compartments;
a lid coupled to the medication tray;
a sensor configured to detect an interaction with the lid in relation to the medication tray; and
a processor operably coupled to the sensor, the processor configured to:
determine that a medication consumption period is active,
determine that the sensor has not detected an interaction with the lid in relation to the medication tray during the medication consumption period, and
activate a notification based on not detecting an interaction with the lid in relation to the medication tray during the medication consumption period.

9. The medication storage container of claim 8, wherein the processor is further configured to:
detect an interaction with the medication storage container; and
deactivate the notification based on the detected interaction.

10. The medication storage container of claim 8, wherein the processor is further configured to:
detect an interaction with the medication storage container during the medication consumption period; and
clear future notifications scheduled for the medication consumption period.

11. The medication storage container of claim 8, further comprising:
a second sensor configured to detect a user in proximity to the medication storage container,
wherein the processor is operably coupled with the second sensor and is further configured to:
detect a user in proximity of the medication storage container, and
in response to detecting a user in proximity of the medication storage container, activate a second notification based on not detecting an interaction with the medication storage container during the medication consumption period.

12. The medication storage container of claim 8, wherein the interaction with the medication storage container is detecting a position of the lid changes; and
deactivate the notification based on the position of the lid changing.

13. The medication storage container of claim 8, further comprising:
a user input configured to stop the medication consumption period,
wherein the processor is operably coupled to the user input and further configured to transmit a message indicating that the medication consumption period was stopped using the user input.

14. The medication storage container of claim 8, wherein the processor is further configured to:
determine the medication consumption period has ended without detecting an interaction with the medication storage container, and
transmit a message indicating that the medication consumption period has ended without detecting an interaction with the medication storage container.

15. A medication storage container comprising:
a housing configured to store separately packaged medication;
a sensor configured to detect an interaction with the separately packaged medication in relation to the housing; and
a processor operably coupled to the sensor, the processor configured to:
determine that a medication consumption period is active,
determine that the sensor has not detected an interaction with the separately packaged medication in relation to the housing during the medication consumption period, and
activate a notification based on not detecting an interaction with the separately packaged medication in relation to the housing during the medication consumption period.

16. The medication storage container of claim 15, wherein the processor is further configured to:
detect an interaction with the medication storage container; and
deactivate the notification based on the detected interaction.

17. The medication storage container of claim 15, wherein the processor is further configured to:
detect an interaction with the medication storage container during the medication consumption period; and
clear future notifications scheduled for the medication consumption period.

18. The medication storage container of claim 15, further comprising:
a second sensor configured to detect a user in proximity to the medication storage container,
wherein the processor is operably coupled with the second sensor and is further configured to:
detect a user in proximity of the medication storage container, and
in response to detecting a user in proximity of the medication storage container, activate a second notification based on not detecting an interaction with the medication storage container during the medication consumption period.

19. The medication storage container of claim 15, further comprising:
a user input configured to stop the medication consumption period,
wherein the processor is operably coupled to the user input and further configured to transmit a message indicating that the medication consumption period was stopped using the user input.

20. The medication storage container of claim 15, wherein the processor is further configured to:
determine the medication consumption period has ended without detecting an interaction with the medication storage container, and
transmit a message indicating that the medication consumption period has ended without detecting an interaction with the medication storage container.
